(19) United States
(12) Patent Application Publication
(10) Pub. No.: US 2007/0250933 A1
(43) Pub. Date: Oct. 25, 2007

(54) APPARATUS, METHOD, AND COMPUTER PROGRAM PRODUCT FOR MANAGING ACCESS RIGHTS IN A DYNAMIC NODE

(75) Inventor: Mika A. Rantanen, Ruutana (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/379,506

(22) Filed: Apr. 20, 2006

(51) Int. Cl. H04N 7/16

(52) U.S. Cl. 726/26

(57) ABSTRACT

An apparatus, method and computer program product enable a device management server to access and modify the settings of a dynamic node that was not created by the DM server, while preventing unlimited access to the dynamic node by not including a replace access right in the root node of the client device in which the dynamic node was created. A predefined set of access rights are written into the dynamic node in response to the first instance of a “get” command from the DM server, thus enabling the DM server to access and modify the settings of the dynamic node.

### FIELD OF THE INVENTION

Exemplary embodiments of the invention generally relate to device management and, more particularly, relate to apparatuses, methods, and computer program products for managing access rights in a device management system.

### BACKGROUND OF THE INVENTION

As data processing devices, such as mobile stations (e.g., mobile telephones), are becoming increasingly complex, the importance of device management increases. Devices require a variety of different settings, such as those related to Internet access points (APs), the setting of which manually by the user is difficult. To solve this and other problems, device management solutions have been provided with which the administrator of a company data system or an operator of a telecommunications system, for example, can set an appropriate configuration in a device. Generally, device management refers to measures with which the configuration of a device can be changed from outside the device, for instance by changing settings or even a protocol used by the device. In addition to settings related to the device only, user-specific data can also be sent, for instance user profiles, logos, ringing tones and menus with which the user can modify device settings to personalize the device.

One device management standard is the Open Mobile Alliance (OMA) Device Management Protocol. OMA device management also comprises content provisioning (CP) technology, in which the configuration is transmitted to a client device by using provisioning technology. OMA device management is bidirectional technology. A personal computer (PC), for instance, can serve as the device management server (DM server), and a mobile station can serve as the device management client (DM client). The client device that functions, from the device management viewpoint, as the client in the session sends information about itself in the session initialization message to the DM server performing device management, and the DM server replies to this by sending its own information as well as server management commands to the client device. The client device replies to these with status information, after which the server can end the session or send more device management commands. If the server sends more management commands, the client device must reply to these with status information. After receiving the status information, the server can always end the session, or the server can continue the session by transmitting more device management commands. Device management may also be implemented in such a way that first the user is sent questions about what the user wishes to update, and then information on the user's choices is sent to the server. After this the server can, in the next packet, transmit the updates/operations that the user wishes to have.

In a client device, the matters to be managed are arranged as management objects. Management objects are entities in the client device that can be managed by management commands of the DM server. In OMA device management, the management objects are arranged in the form of a tree, i.e. as a management tree as illustrated in FIG. 1. The management tree is formed of nodes, and the management object is a subtree to the management tree and can be formed of one or more nodes. After this, it is the nodes forming management objects that are dealt with. A node can be a single parameter, a subtree or a collection of data. In the example illustrated in FIG. 1, node “Vendor” is an interior node, because it has child nodes “Screen Saver” and “Ringing Tones.” Node “Screen Saver” is a leaf node, because it has no child nodes. Also node “Ringing Tones” is an interior node, because it has child nodes. The nodes can be permanent or dynamic. Permanent nodes typically cannot be deleted. Dynamic nodes can be added by a client device or by a DM server, and typically can be deleted as desired. Dynamic nodes may be added using device management, content provisioning, user interface, or other methods.

Each node will typically contain an access control list (ACL) defining what changes can be made to the node and by which entity(ies). The changes that can be made are defined by one or more access rights specified in the ACL. The typical access rights that may be specified are: (1) add access; (2) replace access; (3) get access; (4) delete access; and (5) execute (“exec”) access. If a dynamic node is created by a DM server, the DM server will typically have replace access rights for the created node. Therefore, the DM server can set the access rights in the dynamic node created by the DM server to enable the DM server to manage the settings of such a node. Access rights and ACLs are further described in OMA Device Management Tree and Description, Candidate Ver. 1.2, Open Mobile Alliance Ltd., Jun. 7, 2005, the contents of which are incorporated herein in its entirety.

However, for dynamic nodes which are not created by the DM server (e.g., those that have been created by user interface (UI) or CP), the ACL is inherited from the root node (i.e., the dynamic node will have the same ACL as the root node). In order to enable the DM server to modify such nodes, the current version of the OMA Device Management Tree and Description indicates that the root node ACL should contain a replace access right (typically in the format “replace=*”). This would cause any dynamic nodes created by means other than the DM server (e.g., UI or CP), to also contain a replace access right, thereby enabling the DM server to manage the settings of those dynamic nodes.

However, this procedure of including a replace access right in the root node ACL causes a serious security hole in the DM system. Because the root node ACL is inherited to all other nodes, any server (including a hostile server) can manage all the settings which can be managed via DM. For example, a hostile server can change existing network access points to cause a user to connect to the hostile server instead of the correct one.

As such, there is a need for a method of enabling a DM server to manage dynamic nodes that were not created by the DM server, without the security problems associated with including a replace access right in the root node ACL.

### BRIEF SUMMARY OF THE INVENTION

An apparatus, method and computer program product are provided that enable a device management server to access and modify the settings of a dynamic node that was not created by the DM server, while preventing unlimited access to the dynamic node by not including a replace access right in the root node of the client device in which the dynamic node was created. A predefined set of access rights is written into the dynamic node in response to the first instance of a “get” command from the DM server, thus enabling the DM server to access and modify the settings of the dynamic node.

In one exemplary embodiment, an apparatus for managing access rights in a dynamic node in a system comprising a first device and a second device managing the first device according to a device management protocol is provided in which the apparatus comprises a processing element configured to provide a device management tree structure in the first device. The tree structure defines a plurality of nodes, including at least a root node, with the root node having an access control list that does not contain a replace access right. The processing element is further configured to, when the second device issues a command to read the tree structure of the first device, write a predefined set of access rights into an access control list of any dynamic nodes which are children of an interior node specified in the issued command and which do not already contain the predefined set of access rights. The processing element may be further configured to write the predefined set of access rights only one time after the second device issues the command to read the tree structure of the first device.

The processing element may be further configured to execute a device management client application, such that the device management client application writes the predefined set of access rights. The predefined set of access rights may comprise at least one of an add access right, a replace access right, a get access right, a delete access right or an execute access right. The set of access rights written into the access control list of at least one dynamic node may be modified by the second device such that only the second device is capable of accessing the at least one dynamic node.

The apparatus may be embodied in the first device, and the first device may comprise a mobile communication device. The device management protocol may conform to an Open Mobile Alliance Device Management Protocol.

In addition to the apparatus for managing access rights in a dynamic node in a device management system described above, other aspects of embodiments of the invention are directed to corresponding methods and computer program products for managing access rights in a dynamic node in a device management system.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a management tree of a client device that may benefit from embodiments of the invention;

FIG. 2 illustrates three device management systems that may benefit from embodiments of the invention;

FIG. 3 illustrates a block diagram of a device management server and a client device, in accordance with an exemplary embodiment of the invention; and

FIG. 4 is a flowchart of the operation of managing access rights in a dynamic node in a device management system, in accordance with an exemplary embodiment of the invention.

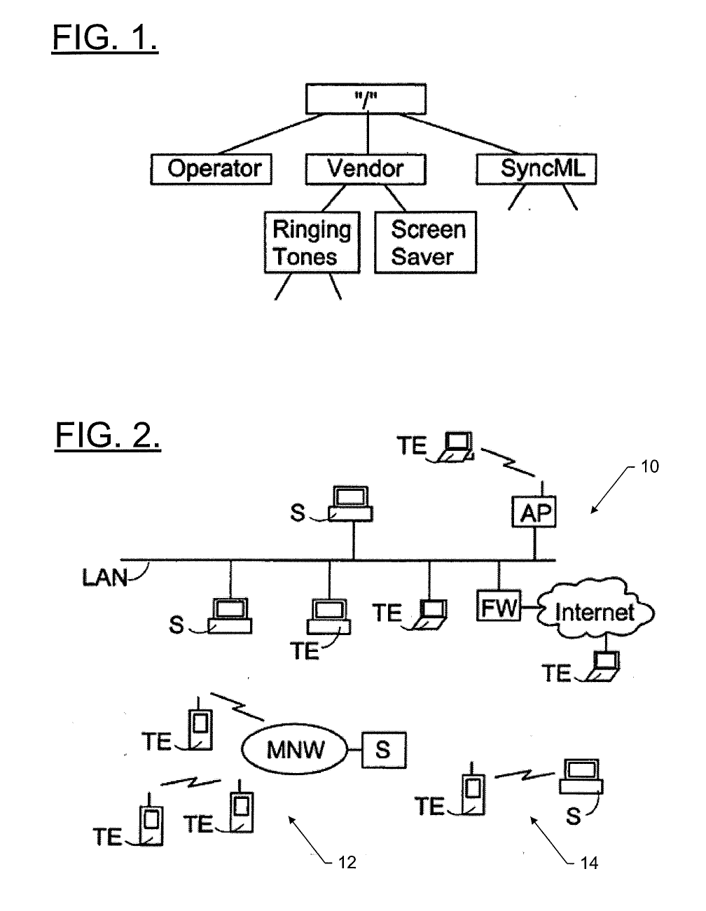

### DETAILED DESCRIPTION OF THE INVENTION

Exemplary embodiments of the invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of embodiments of the invention to those skilled in the art. Like numbers refer to like elements throughout.

Exemplary embodiments of the invention will be described herein relative to a system supporting the OMA device management protocol. It is to be noted, however, that embodiments of the invention can be applied to any device management system in which access rights can be specified in a node defined in a client device.

Referring now to FIG. 2, three networked device management systems that may benefit from embodiments of the invention are illustrated. Each system includes a DM server and one or more client devices. A network entity, such as server S, commonly embodied by a network server or a PC, typically functions as the DM server. A terminal TE, such as a mobile telephone, a PC, a laptop computer or a Personal Digital Assistant (PDA), typically functions as the client device. The DM server may manage several client devices.

In the first DM system 10 illustrated in FIG. 2, client devices TE and DM servers S are connected to a local area network LAN. The client devices TE connected to the network LAN comprise functionality to communicate with other devices in the network LAN, such as a network interface card and software that controls data transmission and reception. The local area network LAN can be a local area network of any type, and the TE may also communicate with the server S via a wide area network, such as the Internet, typically by using a firewall FW. The client device TE may also be connected to the local area network LAN wirelessly via an access point AP.

In the second DM system 12, the client device TE communicates with the DM server S via a mobile network MNW. The client device TE connected to the network MNW comprises mobile station functionality to communicate with the network MNW wirelessly. There may additionally be other networks, such as a local area network LAN, between the mobile network MNW and the DM server S. The mobile network MNW can be any known wireless network, such as a network supporting the Global System for Mobile Communications (GSM) protocol, a network supporting the General Packet Radio Service (GPRS) protocol, a third-generation mobile network (e.g. a network conforming to the network specifications of the 3rd Generation Partnership Project (3GPP)), a wireless local area network (WLAN), a private network or a combination of networks. In the third DM system 14, the client device TE and the DM server S may be directly connected via a wired or wireless connection without other network elements.

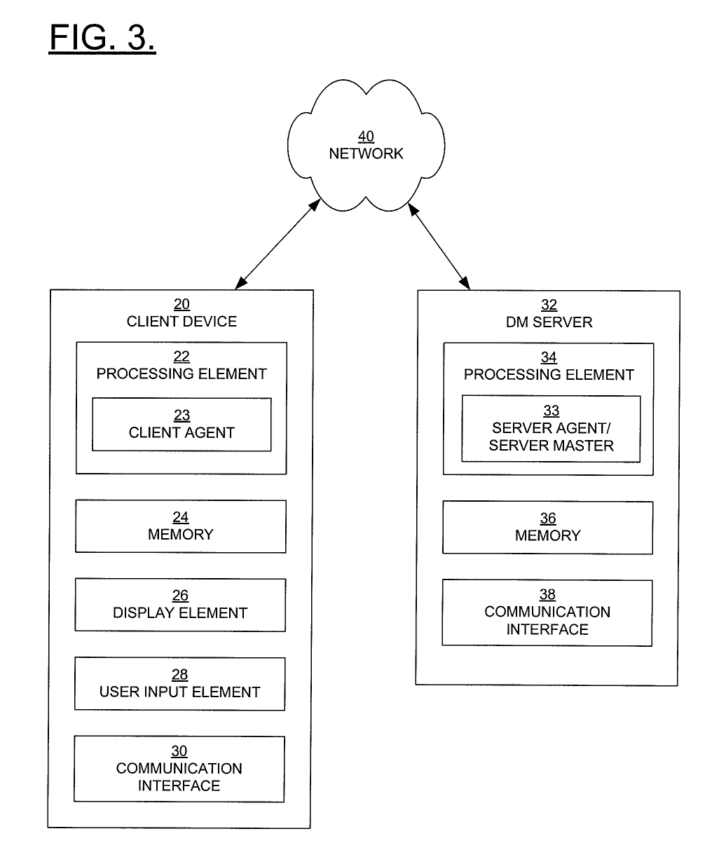

Referring now to FIG. 3, a block diagram of a client device (such as terminal TE of FIG. 2) and a DM server are illustrated, in accordance with an exemplary embodiment of the invention. Client device 20 of FIG. 3 may be any device capable of functioning as a client device in a device management system, whether the device is personal computer, a laptop computer, a mobile telephone, a PDA, or any other type of device. As shown, the client device 20 generally includes a processing element 22 capable of executing a client application. While the processing element can be configured in various manners, the processing element may be comprised of a microprocessor, controller, dedicated or general purpose electronic circuitry, a suitably programmed computing device, or other means for executing a client application. Processing element 22 may include or be connected to or otherwise be capable of accessing a memory 24. The memory can comprise volatile and/or non-volatile memory or other storage means, and typically stores content, applications, data, or the like.

In addition to the memory 24, the processing element 22 may also be connected to at least one interface or other means for transmitting and/or receiving data or the like. In this regard, the interface(s) can include at least one communication interface 30 or other means for transmitting and/or receiving data. The communication interface 30 may communicate with and receive data from external devices, such as DM server 32, using any known communication technique, whether wired or wireless, including but not limited to serial, universal serial bus (USB), Ethernet, Bluetooth, wireless Ethernet (i.e., WiFi), cellular, infrared, and general packet radio service (GPRS). The communication interface 30 may enable the client device to communicate via a network 40, which may be the Internet, a mobile telephone network, or any other suitable communication network. The processing element may also be connected to at least one user interface that may include a display element 26 and/or a user input element 28. The user input element, in turn, may comprise any of a number of devices allowing the client device to receive data and/or commands from a user, such as a keypad, a touch display, a joystick or other input device.

A management tree, defining management objects, may be stored in the memory 24 of the client device 20. The client device, functioning as a client device according to the OMA device management standard, comprises a client agent 23 that is responsible for the functions relating to a management session in the client device. The client agent 23 can be implemented by executing in the processing element 22 a computer program code stored in the memory 24. As noted above, a client device can additionally function as a DM server. Thus, although not illustrated in FIG. 3, the client device may also comprise at least part of the functions of a server agent, enabling the client device to function as a DM server.

Device management server 32 of FIG. 3 may be any device capable of functioning as a DM server in a device management system. As shown, the DM server 32 generally includes a processing element 34 capable of executing a server application. While the processing element can be configured in various manners, the processing element may be comprised of a microprocessor, controller, dedicated or general purpose electronic circuitry, a suitably programmed computing device, or other means for executing a client application. Processing element 34 may include or be connected to or otherwise be capable of accessing a memory 36. The memory can comprise volatile and/or non-volatile memory or other storage means, and typically stores content, applications, data, or the like.

In addition to the memory 36, the processing element 34 may also be connected to at least one interface or other means for transmitting and/or receiving data or the like. In this regard, the interface(s) can include at least one communication interface 38 or other means for transmitting and/or receiving data. The communication interface 38 may communicate with and receive data from external devices, such as client device 20, using any known communication technique, whether wired or wireless, including but not limited to serial, universal serial bus (USB), Ethernet, Bluetooth, wireless Ethernet (i.e., WiFi), cellular, infrared, and general packet radio service (GPRS). The communication interface 38 may enable the DM server to communicate via network 40.

A device functioning as a DM server in an OMA device management system, such as DM server 32, comprises a server agent SA or server master SM 33 attending to a management session. The server agent 33 can be implemented by executing in the processing element 34 a computer program code stored in the memory 36.

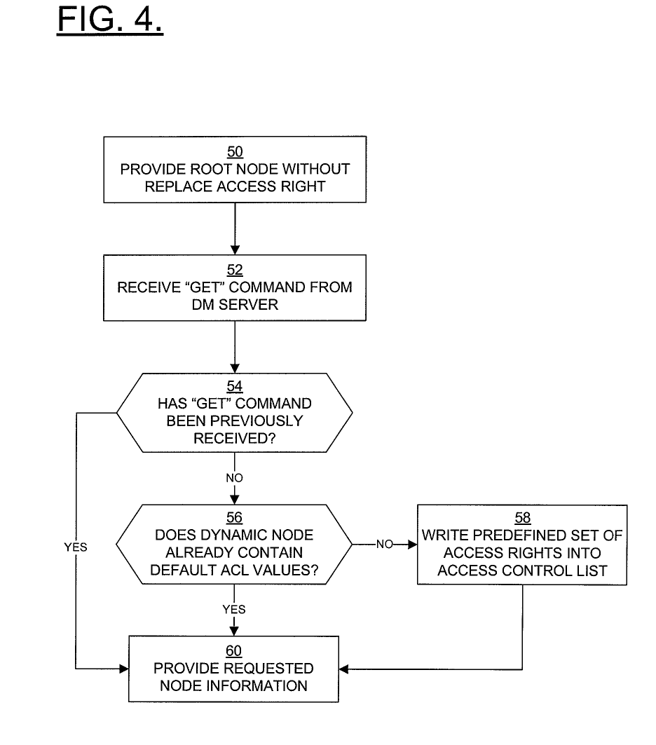

Referring now to FIG. 4, a flowchart of the operation of managing access rights in a dynamic node in a device management system is illustrated, in accordance with an exemplary embodiment of the invention. FIG. 4 illustrates managing access rights in a device management system, such as a system comprising the client device 20 and the DM server 32 of FIG. 3, in which the DM server is managing the client device according to a device management protocol, such as the OMA Device Management Protocol. A device management tree structure is provided in the client device, with the tree structure defining a plurality of nodes including a root node. The root node is provided having an ACL that does not contain a replace access right. See block 50. Because the root node ACL does not have a replace access right, the other nodes in the tree structure would also typically not have a replace access right. The root node is provided without a replace access right, despite the OMA Device Management Protocol suggestion to include a replace access right in the root node, in order to prevent the security hole caused by having such a replace access right in the root node. The root node ACL would, however, typically have a get access right (typically in the format “Get=*”) to enable the DM server to access the settings of any node in the tree (as the get access right will be inherited to all nodes).

When the DM server wishes to access a node in the client device, the DM server issues a “get” command which will then be received by the client device. See block 52. The “get” command will typically specify the node which the DM server wishes to access. If the specified node is an interior node, the child node(s) (which may be dynamic nodes) of the specified node can also be accessed. The client device will typically determine if such a “get” command has been previously received. See block 54. If a “get” command has not been previously received, the client device will then typically determine if the ACL(s) of the accessed node(s) already contains a predefined list of access rights (this predefined list of access values may be termed the “default ACL values”). See block 56. As discussed above, if one of the accessed nodes is a dynamic node created by the DM server, the DM server will typically have replace access rights to enable the DM server to manage the settings of such a node. Thus, the ACL of such a dynamic node will typically already contain the default ACL values. However, for dynamic nodes which are not created by the DM server (e.g., those that have been created by user interface (UI) or CP), the ACL is inherited from the root node. As the root node does not contain a replace access right, in accordance with embodiments of the invention, the ACL of the dynamic node will not have the default ACL values. Thus, to enable the DM server to manage the settings of the node, the default ACL values are written into the ACL of the accessed dynamic node if it is determined in block 56 that the ACL does not already contain the default values. See block 58. The default ACL values typically comprise an add access right, a replace access right, a get access right, a delete access right and an execute access right. To summarize blocks 54-58, the client device writes (one time, as discussed below) a predefined set of access rights into the ACL of any dynamic nodes which are children of an interior node specified in the issued “get” command and which do not contain the predefined set of access rights. The default ACL values will typically be written by a device management client application, such as client agent 23, executing in the client device 20. If it is determined in block 56 that the dynamic node already contains the default ACL values (typically because the DM server wrote them in when the dynamic node was created), then no changes are made to the node and the requested node information is provided to the DM server. See block 60.

If it is determined in block 54 that a “get” command has already been received, then no changes are made to the node and the requested node information is provided to the DM server. See block 60. This means that the default ACL values are written into the ACL only one time. Thus, the first DM server that accesses the dynamic node(s) will be granted access to and control of the node(s). It will typically be desirable, then, to ensure that the first DM server to access the dynamic node(s) is a non-hostile DM server. Once a DM server has been control of a node, the DM server can modify the ACL of the node such that only the DM server is capable of accessing the node.

The method for managing access rights in a dynamic node in a device management system may be embodied by a computer program product. The computer program product includes a computer-readable storage medium, such as the non-volatile storage medium, and computer-readable program code portions, such as a series of computer instructions, embodied in the computer-readable storage medium. Typically, the computer program is stored by a memory device, such as memory 24, and executed by an associated processing unit, such as processing element 22.

In this regard, FIG. 4 is a flowchart of methods and program products according to embodiments of the invention. It will be understood that each step of the flowchart, and combinations of steps in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart step(s).

Accordingly, steps of the flowchart support combinations of means for performing the specified functions, combinations of steps for performing the specified functions and program instruction means for performing the specified functions. It will also be understood that each step of the flowchart, and combinations of steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus for managing access rights in a dynamic node in a system comprising a first device and a second device managing the first device according to a device management protocol, the apparatus comprising:
a processing element configured to provide in the first device a device management tree structure, the tree structure defining a plurality of nodes, including at least a root node, the root node having an access control list that does not contain a replace access right; and wherein the processing element is further configured to, when the second device issues a command to read the tree structure of the first device, write a predefined set of access rights into an access control list of any dynamic nodes which are children of an interior node specified in the issued command and which do not contain the predefined set of access rights.

2. The apparatus of claim 1, wherein the processing element is further configured to write the predefined set of access rights only one time after the second device issues the command to read the tree structure of the first device.

3. The apparatus of claim 1, wherein the processing element is further configured to execute a device management client application, such that the device management client application writes the predefined set of access rights.

4. The apparatus of claim 1, wherein the predefined set of access rights comprises at least one of an add access right, a replace access right, a get access right, a delete access right or an execute access right.

5. The apparatus of claim 1, wherein the set of access rights written into the access control list of at least one dynamic node is modified by the second device such that only the second device is capable of accessing the at least one dynamic node.

6. The apparatus of claim 1, embodied in the first device.

7. The apparatus of claim 6, wherein the first device comprises a mobile communication device.

8. The apparatus of claim 1, wherein the device management protocol conforms to an Open Mobile Alliance Device Management Protocol.

9. A method for managing access rights in a dynamic node in a system comprising a first device and a second device managing the first device according to a device management protocol, the method comprising:
providing in the first device a device management tree structure, the tree structure defining a plurality of nodes, including at least a root node, the root node having an access control list that does not contain a replace access right; and
when the second device issues a command to read the tree structure of the first device, writing a predefined set of access rights into an access control list of any dynamic nodes which are children of an interior node specified in the issued command and which do not contain the predefined set of access rights.

10. The method of claim 9, wherein writing the predefined set of access rights comprises writing the predefined set of access rights only one time after the second device issues the command to read the tree structure of the first device.

11. The method of claim 9, wherein writing the predefined set of access rights comprises writing the predefined set of access rights by a device management client application executing in the first device.

12. The method of claim 9, wherein the predefined set of access rights comprises at least one of an add access right, a replace access right, a get access right, a delete access right or an execute access right.

13. The method of claim 9, further comprising:
modifying by the second device the set of access rights written into the access control list of at least one dynamic node such that only the second device is capable of accessing the at least one dynamic node.

14. The method of claim 9, wherein the first device comprises a mobile communication device.

15. The method of claim 9, wherein the device management protocol conforms to an Open Mobile Alliance Device Management Protocol.

16. A computer program product for managing access rights in a dynamic node in a system comprising a first device and a second device managing the first device according to a device management protocol, the computer program product comprising at least one computer-readable storage medium having computer-readable program code portions stored therein, the computer-readable program code portions comprising:
a first executable portion configured to provide in the first device a device management tree structure, the tree structure defining a plurality of nodes, including at least a root node, the root node having an access control list that does not contain a replace access right; and
a second executable portion configured to, when the second device issues a command to read the tree structure of the first device, write a predefined set of access rights into an access control list of any dynamic nodes which are children of an interior node specified in the issued command and which do not contain the predefined set of access rights.

17. The computer program product of claim 16, wherein the second executable portion is configured to write the predefined set of access rights only one time after the second device issues the command to read the tree structure of the first device.

18. The computer program product of claim 16, the second executable portion comprises a device management client application.

19. The computer program product of claim 16, wherein the predefined set of access rights comprises at least one of an add access right, a replace access right, a get access right, a delete access right or an execute access right.

20. The computer program product of claim 16, further comprising:
wherein the set of access rights written into the access control list of at least one dynamic node is modified by the second device such that only the second device is capable of accessing the at least one dynamic node.

21. The computer program product of claim 16, wherein the first device comprises a mobile communication device.

22. The computer program product of claim 16, wherein the device management protocol conforms to an Open Mobile Alliance Device Management Protocol.

23. An apparatus for managing access rights in a dynamic node in a system comprising a first device and a second device managing the first device according to a device management protocol, the apparatus comprising:
means for providing in the first device a device management tree structure, the tree structure defining a plurality of nodes, including at least a root node, the root node having an access control list that does not contain a replace access right; and
means for, when the second device issues a command to read the tree structure of the first device, writing a predefined set of access rights into an access control list of any dynamic nodes which are children of an interior node specified in the issued command and which do not contain the predefined set of access rights.

24. The apparatus of claim 23, wherein the writing means writes the predefined set of access rights only one time after the second device issues the command to read the tree structure of the first device.

25. The apparatus of claim 23, wherein the predefined set of access rights comprises at least one of an add access right, a replace access right, a get access right, a delete access right or an execute access right.

26. The apparatus of claim 23, embodied in the first device.

27. The apparatus of claim 26, wherein the first device comprises a mobile communication device.
